(19) United States
(12) Patent Application Publication
(10) Pub. No.: US 2015/0292725 A1
(43) Pub. Date: Oct. 15, 2015

(54) LIGHTING DEVICE

(71) Applicant: OSRAM GMBH, München (DE)

(72) Inventors: Tingming Liu, Shenzhen (CN); Jianghui Yang, Shenzhen (CN); Shengmei Zheng, Shenzhen (CN); Aiai Li, Shenzhen (CN)

(21) Appl. No.: 14/438,639

(22) PCT Filed: Nov. 8, 2013
(86) PCT No.: PCT/EP2013/073438

§ 371 Date: Apr. 27, 2015

(30) Foreign Application Priority Data
Nov. 9, 2012 (CN) 201210448638.2

(51) Int. Cl. F21V 29/70; F21V 3/02; F21K 99/00; F21V 29/85; F21V 23/00

(52) U.S. Cl. CPC F21V 29/70; F21V 29/86; F21V 23/002; F21K 9/1355; F21V 3/02; F21Y 2101/02

(57) ABSTRACT

Various embodiments may relate to a lighting device, including an electronic device housing, an electrical connecting part mounted at one side of the electronic device housing, a heat sink mounted at the other side of the electronic device housing, and a plurality of light sources arranged on the heat sink. The heat sink is made of a transparent material and forms at least a part of a light emergent surface for the light from the light sources.

### RELATED APPLICATIONS

The present application is a national stage entry according to 35 U.S.C. §371 of PCT application No.: PCT/EP2013/073438 filed on Nov. 8, 2013, which claims priority from Chinese application No. 201210448638.2 filed on Nov. 9, 2012, and is incorporated herein by reference in its entirety.

### TECHNICAL FIELD

Various embodiments may relate to a lighting device, and especially, to an LED retrofit lamp for omnidirectional lighting.

### BACKGROUND

As known to all, LED lighting has irreplaceable advantages, for example, it saves energy, has ultra low power consumption and an electro-optical power conversion of nearly 100%, saves energy by 80% compared with traditional light sources under the same lighting efficiency, and also has a long service life. In view of the above advantages, the LED is used as light sources more and more, for example, an LED retrofit lamp appearing in the market in a large scale. The LED retrofit lamp has the contour of traditional light sources such as an incandescent lamp or lamp tube, thus it can better adapt to existing light systems as alight source.

The related art discloses an LED retrofit lamp, including: a lamp head for connection with a power source; a heat sink fixed at the lamp heat at one end and contacting a printed circuit board bearing an LED chip at the other end; and a semispherical bulb provided at the other end of the heat sink and sealing the printed circuit board bearing the LED chip. In this type of LED retrofit lamp, the heat sink and the bulb fixed at the heat sink jointly form a contour complying with the bulb of an incandescent lamp, so that the LED retrofit lamp is similar to traditional incandescent lamps in appearance. However, the heat sink of the LED retrofit lamp blocks the light and then limits the omnidirectional lighting performance of the LED retrofit lamp.

### SUMMARY

To solve the above technical problem, various embodiments provide a lighting device, especially an LED retrofit lamp for omnidirectional lighting. The lighting device has an appearance and a contour very similar to those of traditional incandescent lamps, and can also provide excellent omnidirectional lighting performance.

Various embodiments provide a lighting device, especially an LED retrofit lamp for omnidirectional lighting, that is, the lighting device includes an electronic device housing, an electrical connecting part mounted at one side of the electronic device housing, a heat sink mounted at the other side of the electronic device housing, and a plurality of light sources arranged on the heat sink, wherein, the heat sink is made of a transparent material and forms at least a part of a light emergent surface for the light from the light sources. In this lighting device, as the heat sink is made of a transparent material, it will not block the light emitted from the light sources, thus, during designing the lighting device, it need not be considered that the position of the heat sink may block the light emitted from the light sources. As a result, it is more flexible in designing the lighting device and the omnidirectional lighting can be achieved more easily.

In various embodiments, the heat sink includes an end plate for supporting the light sources, which is designed to be a circuit board. That is to say, the light sources, especially LED chips as the light sources, may be directly arranged on the heat sink through a surface mounting technology or other assembling technology. Thus, the heat from the LED chips may be directly transferred to the heat sink, which greatly enhances the heat dissipation performance of the heat sink and improves the service life of the light sources.

In various embodiments, the heat sink includes a base body designed to be hollow, and an opening end of the base body distal from the electronic device housing is closed by the end plate, wherein the base body and the end plate are designed so that the light from the light sources may emerge through the base body and the end plate. Some electrical connecting parts such as a conductive wire maybe provided in the hollow base body. Meanwhile, some gas which may enhance heat dissipation may be filled in the hollow base body, thereby further improving the heat dissipation performance of the heat sink.

In various embodiments, the base body and the end plate are integrally formed. Therefore, there will be no gap between the base body and the end plate, which greatly reduces the thermal resistance in the heat conduction path between the base body and the end plate, and improves the heat dissipation performance. In addition, integrally forming the base body and the end plate can greatly simplify the manufacturing process.

In various embodiments, the heat sink is made of glass. Of course, the heat sink may also be made of a transparent material that can bear a high temperature.

In various embodiments, two surfaces of the endplate facing each other are formed to be a first mounting surface and a second mounting surface for assembling the light sources. The light sources are respectively arranged on the first mounting surface and the second mounting surface. Therefore, the light emitted from the light sources arranged on the two mounting surfaces respectively covers two semispherical areas of 180 degrees, thereby achieving omnidirectional lighting of 360 degrees. Of course, the electronic device housing and the electrical connecting part will block the light to a certain extent, while this is minute to the omnidirectional lighting of the lighting device.

In various embodiments, the light sources are arranged on the first mounting surface and the second mounting surface in a circular shape. The circular arrangement of the light sources helps more even distribution of the light in a circumferential direction.

In various embodiments, the lighting device further includes a bulb, and the bulb and the heat sink jointly define the shape of the bulb of an incandescent lamp. In various embodiments, the bulb actually is in a semispherical shape, and provided at one side of the endplate of the heat sink. In addition, the outer contour of the base body of the heat sink is designed to match contour of the bulb, so as to form with the bulb the shape of the bulb of a traditional incandescent lamp with smooth transition.

In various embodiments, the lighting device further includes at least two conductive wires, wherein, the light sources are electrically connected with the electronic devices provided within the electronic device housing through the conductive wires. Such conductive wires may be rigid metal wires, so as to form in the hollow base body of the heat sink a contour similar to the conductive path of the traditional incandescent lamp, and then the lighting device according to various embodiments looks more like the traditional incandescent lamp.

In various embodiments, the light sources are LED chips, which have a high light emitting efficiency, a long service life, are environmentally friendly, and save energy.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is an exploded schematic diagram of the lighting device according to various embodiments;

FIG. 2 is a schematic diagram of the end plate of the heat sink of the lighting device according to various embodiments; and

FIG. 3 is a schematic diagram of the lighting device according to various embodiments which is in an assembled state.

### DETAILED DESCRIPTION

In the following detailed description, reference is made to the accompanying drawings, which form a part hereof, and in which specific embodiments is shown by way of illustration, by which the present invention can be implemented. In this regard, directional terminology, such as “upper”, “lower” and “circumferential”, is used in reference to the orientation of the figures being described. Because components of embodiments of the present invention can be positioned in a number of different orientations, the directional terminology is used for purposes of illustration and is in no way limiting. It is to be understood that other embodiments may be utilized and structural or logical changes may made without departing from the scope of the present invention. The following detailed description, therefore, is not to be taken in a limiting sense, and the scope of the present invention is defined by the appended claims.

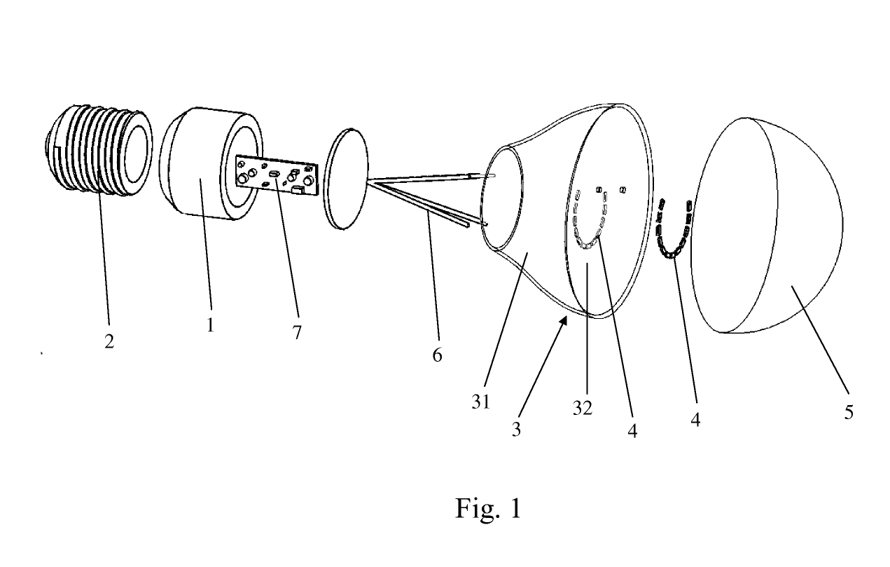

FIG. 1 is an exploded schematic diagram of the lighting device 100 according to various embodiments. Seen from the drawing, the lighting device 100 includes an electronic device housing 1, an electrical connecting part 2 mounted at one side of the electronic device housing 1, a heat sink 3 mounted at the other side of the electronic device housing 1, and a plurality of light sources 4 arranged on the heat sink 3 and designed to be LED chips. In addition, further seen from the drawing, the lighting device 100 further includes a bulb 5. In various embodiments, the lighting device 100 is designed to be an LED retrofit lamp for achieving omnidirectional lighting, wherein, the electronic device housing 1 is used to receive a driver 7 driving the LED chips. The electrical connecting part is designed to be a lamp head which is inserted into the lamp holder of a traditional incandescent lamp.

In addition, further seen from the drawing, the heat sink 3 is made of a transparent material, in this embodiment, the heat sink 3 is made of glass, of course, the heat sink 3 may also be made of other transparent materials that can bear a high temperature. The heat sink 3 is designed to be a hollow base body 31, and one opening end of the base body 31 distal from the electronic device housing 1 is closed by the endplate 32. Some gas which can enhance heat dissipation may be filled in the hollow base body 31, for example, an inert gas, so as to further improve the heat dissipation performance of the heat sink. As the base body 31 and the end plate 32 are made of glass, the light from the light sources 4 may emerge through the base body 31 and the end plate 32. In addition, in this embodiment, the base body 31 and the end plate 32 are integrally formed. Therefore, there will be no gap between the base body 31 and the end plate 32, thereby greatly reducing the thermal resistance at the heat conduction path between the base body 31 and the end plate 32 and improving the heat dissipation performance. In addition, integrally forming the base body 31 and the end plate 32 may greatly simplify the manufacturing process.

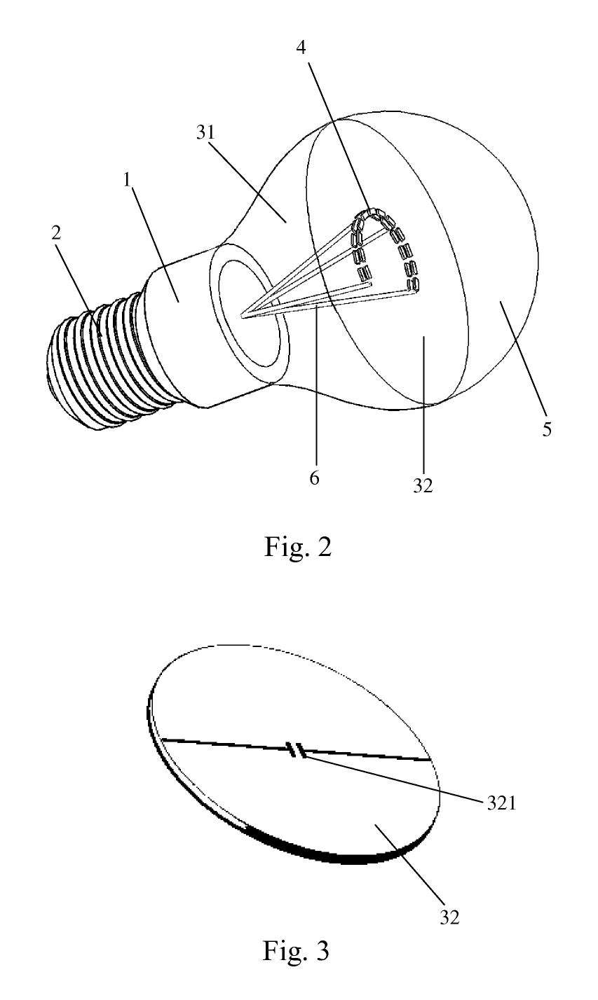

In addition, in this embodiment, the endplate 32 forms a circuit board for bearing the light sources 4. The specific structure of the end plate 32 will be described in FIG. 2. Seen from FIG. 1, two surfaces of the end plate 32 facing each other are formed to be a first mounting surface and a second mounting surface for assembling the light sources 4. Therefore, the light emitted from the light sources 4 arranged on the two mounting surfaces respectively covers two 180-degree semispherical areas at the left side and the right side in the drawing, thereby achieving omnidirectional lighting of 360 degrees. In addition, further seen from the drawing, the multiple light sources 4 are respectively arranged on the first mounting surface and the second mounting surface. In this embodiment, such light sources 4 are arranged on the first mounting surface and the second mounting surface in a circular shape. The circular arrangement of the light sources 4 helps more even distribution of the light in a circumferential direction.

In addition, further seen from FIG. 1, the lighting device 100 further includes at least two conductive wires 6, and in this embodiment four such conductive wires 6 are provided. The light sources 4 on the two mounting surfaces of the end plate are electrically connected with a driver in the electronic device housing 1 through the two conductive wires 6. In this embodiment, the conductive wires 6 may be rigid metal wires, so as to form in the hollow base body 31 of the heat sink 3 a contour similar to the conductive path of the traditional incandescent lamp, and then the lighting device 100 according to various embodiments looks more like the traditional incandescent lamp.

FIG. 2 is a schematic diagram of the endplate 32 of the heat sink 3 of the lighting device 100 according to various embodiments. The end plate 32 made of glass has two mounting surfaces. Only one mounting surface can be seen from FIG. 2, that is, the first mounting surface. A conductive layer is printed on the first mounting surface through a thick film process, then the light sources 4 designed to be LED chips are mounted to the conductive layer through a surface mounting process. As the related art has disclosed many methods for making glass circuit board, it need not be described herein. In addition, it needs to be emphasized that the drawing only illustrates a conductive contact position 321 for one light source 4 from principle, however, in practical use, the present disclosure is not limited to one conductive contact position 321, and actually multiple conductive contact positions can be arranged, to meet the need of mounting multiple light sources 4.

FIG. 3 is a schematic diagram of the lighting device 100 according to various embodiments which is in an assembled state. Seen from the drawing, the bulb 5 and the heat sink 3 jointly define the shape of the bulb of the incandescent lamp, and jointly form a light emergent surface for the light from the light sources 4. Further seen from the drawing, the bulb 5 is actually in a semispherical shape and mounted at one side of the end plate 32 of the heat sink 3. In addition, the outer contour of the base body 31 of the heat sink 3 is designed to match contour of the bulb 5, so as to form with the bulb 5 the shape of the bulb of a traditional incandescent lamp with smooth transition.

The lighting device 100 according to various embodiments usually uses small-power LED chips as the light sources 4, thus, it can meet the need of heat dissipation when using glass, which does not have fine heat dissipation performance, as the basic material of the heat sink 3. After using the glass heat sink 3, the lighting device 100 has an appearance and a contour very similar to the traditional incandescent lamp, and can also provide excellent omnidirectional performance.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A lighting device, comprising:
an electronic device housing;
an electrical connecting part mounted at one side of the electronic device housing;
a heat sink mounted at the other side of the electronic device housing; and
a plurality of light sources arranged on the heat sink, wherein the heat sink is made of a transparent material and forms at least a part of a light emergent surface for the light from the light sources.

2. The lighting device according to claim 1, wherein the heat sink comprises an end plate for supporting the light sources, which is designed to be a circuit board.

3. The lighting device according to claim 2, wherein the heat sink comprises a base body designed to be hollow, and an opening end of the base body distal from the electronic device housing is closed by the end plate, wherein the base body and the end plate are designed so that the light from the light sources emerge through the base body and the end plate.

4. The lighting device according to claim 3, wherein the base body and the end plate are integrally formed.

5. The lighting device according to claim 1,
wherein the heat sink is made of glass.

6. The lighting device according to claim 2,
wherein two surfaces of the end plate facing each other are formed to be a first mounting surface and a second mounting surface for assembling the light sources.

7. The lighting device according to claim 6,
wherein the light sources are respectively arranged on the first mounting surface and the second mounting surface.

8. The lighting device according to claim 6,
wherein the light sources are arranged on the first mounting surface and the second mounting surface in a circular shape.

9. The lighting device according to claim 1,
wherein the lighting device further comprises a bulb, and the bulb and the heat sink jointly define the shape of the bulb of an incandescent lamp.

10. The lighting device according to claim 1,
wherein the lighting device further comprises at least two conductive wires, wherein, the light sources are electrically connected with the electronic devices provided within the electronic device housing through the conductive wires.

11. The lighting device according to claim 1,
wherein the light sources are LED chips.
